(19) United States
(12) Patent Application Publication
(10) Pub. No.: US 2026/0095484 A1
(43) Pub. Date: Apr. 2, 2026

(54) RAPID ALLOWED RESOURCE REFLECTION

(71) Applicant: CyberArk Software Ltd., Petach-Tikva (IL)

(72) Inventors: Tomer Dayan, Petach-Tikva (IL); Yaron Nisimov, Petach-Tikva (IL)

(73) Assignee: CyberArk Software Ltd., Petach-Tikva (IL)

(21) Appl. No.: 18/899,005

(22) Filed: Sep. 27, 2024

(51) Int. Cl. H04L 9/40; H04L 67/60

(52) U.S. Cl. CPC H04L 63/20; H04L 67/60

(57) ABSTRACT

Disclosed herein are techniques for dynamically identifying at least one network resource accessible to a network identity. Operations may include receiving a request associated with a network identity; identifying a first data element associated with the network identity; generating a plurality of instances of the request; fetching, just in time, based on the first data element and in association with at least one of the plurality of instances of the request, two or more policies associated with the network identity wherein the two or more policies are at least one of: located in two or more data storage locations, associated with two or more policy types, or associated with two or more types of resources; evaluating, just in time, based on the first data element and in association with at least one of the plurality of instances of the request, a batch of one or more policies; and identifying, based on the evaluation, one or more network resources accessible to the network identity.

### FIELD OF DISCLOSURE

The disclosed embodiments generally relate to systems, devices, methods, and computer-readable media for dynamically identifying at least one network resource accessible to a network identity.

### BACKGROUND

A network identity may seek to identify one or more network resources that may be available and accessible to the network identity in real time. For example, a user portal or user dashboard that displays a list of network resources, privileged sessions, audits, access rules, and other privileged computing resources accessible to the network identity may allow the network identity to quickly and efficiently determine which network resources the network identity may be able to access. However, it may be difficult to accumulate a list of accessible network resources because network resources may be of different types, may be stored in different locations, or may be protected with different encryption levels. Further, there may be a large number of policies and corresponding network resources that may need to be parsed to determine all network resources that may be accessible to a particular network identity. This may make it difficult to provide an accurate real-time list of all network resources that are accessible to a network identity.

Caching may be used to provide a list of network resources that are accessible to a user. However, caching may not be able to provide an up-to-date list of available network resources in real time. For example, resources to which access has been revoked from a user since the last cache update may still be provided to the user based on the caching, and in certain embodiments, enable the user’s access to the network resource based on outdated permissions. Conversely, resources to which access is newly allowed may not be provided to the user, and, in certain embodiments, the newly granted access to such resources may not take effect immediately, as the updated permissions have not been reflected in the most recent cache. This may prevent a user from identifying an accurate list of accessible resources. Further, it may be time consuming and expensive to reevaluate the cache and update with changes in access. It may also be difficult to flexibly add more resource types and policy engines. Further, a cache may only be able to partially evaluate a user’s accessibility to various network resources.

Therefore, to address these technical deficiencies in dynamically identifying network resources accessible to a user, solutions should be implemented to provide a just-in-time evaluation of accessible policies and associated network resources across different policy engines. Such solutions should distribute the evaluation of accessible network resources across a plurality of different policy engines to intelligently partition the policies in each engine. Such solutions should also perform a batch evaluation of the partitioned policies and combine the partial results into an accumulation of accessible network resources. Such solutions should also provide a token that may be used to identify and evaluate additional accessible network resources. These and other technological improvements and advantages are discussed below.

### SUMMARY

The disclosed embodiments describe non-transitory computer readable media for dynamically identifying at least one network resource accessible to a network identity. For example, in an embodiment, a non-transitory computer readable medium may include instructions that, when executed by at least one processor, cause the at least one processor to perform operations for dynamically identifying at least one network resource accessible to a network identity. The operations may comprise receiving a request associated with a network identity, identifying a first data element associated with the network identity, generating a plurality of instances of the request, fetching, just in time, based on the first data element and in association with at least one of the plurality of instances of the request, two or more policies associated with the network identity wherein the two or more policies may be at least one of: located in two or more data storage locations, associated with two or more policy types, or associated with two or more types of resources, evaluating, just in time, based on the first data element and in association with at least one of the plurality of instances of the request, a batch of one or more policies, and identifying, based on the evaluation, a one or more network resources accessible to the network identity.

According to a disclosed embodiment, fetching the two or more policies associated with the network identity may comprise fetching the two or more policies from multiple policy engines in association with at least one of the plurality of instances of the request.

According to a disclosed embodiment, fetching the two or more policies associated with the network identity may comprise fetching the two or more policies in parallel in association with at least one of plurality of instances of the request.

According to a disclosed embodiment, generating a plurality of instances of the request may comprise at least one of: fragmenting the request, modifying the request, or duplicating the request.

According to a disclosed embodiment, the first data element may comprise at least one of an authentication token or identification information associated with the network identity.

According to a disclosed embodiment, the two or more policy types may comprise at least two of: a policy for accessing a virtual machine zero standing access, a policy for accessing a database zero standing access, a policy for standing access, a policy for accessing a cloud console, a policy for accessing a web application, a policy for accessing a second policy, or a policy for authorizing one or more identities.

According to a disclosed embodiment, the first data element may be further associated with the one or more network resources accessible to the network identity.

According to a disclosed embodiment, a second data element may be generated based on at least one policy index and at least one resource index.

According to a disclosed embodiment, the two or more data storage locations may comprise at least two of: a relational database management system, a database, a data warehouse, a key-value store, a document store, a columnar database, a graph database, an in-memory data grid, a file system, or an object storage.

According to a disclosed embodiment, the two or more data storage locations may be at least one of a cloud storage location or an on-premises storage location.

According to a disclosed embodiment, the two or more policies may be encrypted or are stored as plain text.

According to a disclosed embodiment, identifying the one or more network resources accessible to the network identity may be performed just in time.

According to a disclosed embodiment, the two or more types of resources may comprise at least two of: a resource associated with a cloud virtual machine, a resource associated with an on-premises virtual machine, a resource associated with an account stored in a vault, or a resource associated with a cloud console workspace.

According to a disclosed embodiment, two or more policies of a same type may be stored in a same storage location.

According to a disclosed embodiment, two or more policies of a same type may be stored in a hybrid data store.

According to a disclosed embodiment, the batch of one or more policies may correspond to a batch of one or more network resources associated with the network identity.

According to a disclosed embodiment, the batch of one or more network resources may be associated with one of the plurality of instances of the request.

According to a disclosed embodiment, the first data element may comprise the second data element.

According to a disclosed embodiment, identifying one or more network resources accessible to the network identity may comprise buffering the network resources accessible to the network identity to equal a page size.

According to a disclosed embodiment, evaluating, just in time, a batch of one or more policies may be performed in parallel.

According to a disclosed embodiment, the operations may further comprise at least one of: displaying the one or more network resources accessible to the network identity on a graphical user interface, sending the one or more network resources accessible to the network identity to the network identity, or storing the one or more network resources accessible to the network identity.

Aspects of the disclosed embodiments may include tangible computer readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, explain the disclosed embodiments.

FIG. 1 is a block diagram of a system for dynamically identifying at least one network resource accessible to a network identity, in accordance with disclosed embodiments.

FIG. 2 is a block diagram of a computing device including an orchestrating policies endpoint for dynamically identifying at least one network resource accessible to a network identity, in accordance with disclosed embodiments.

FIG. 3 is a block diagram of a system for dynamically identifying at least one network resource accessible to a network identity, in accordance with disclosed embodiments.

FIG. 4 is a block diagram of a process for dynamically identifying at least one network resource accessible to a network identity, in accordance with disclosed embodiments.

FIG. 5 is a flowchart of a process for dynamically identifying at least one network resource accessible to a network identity, in accordance with disclosed embodiments.

### DETAILED DESCRIPTION

In the following detailed description, numerous specific details are set forth to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

The techniques for dynamically identifying at least one network resource accessible to a network identity described herein overcome several technological problems relating to the efficiency and functionality of cache systems in evaluating and identifying accessible network resources. In particular, the disclosed embodiments provide techniques for identifying, just-in-time, network resources that are accessible to a network identity across a plurality of policy engines. As discussed above, caching methods may be limited in providing just-in-time identification of network resources because a cache may not be consistently updated to remove restricted network resources and add newly accessible network resources.

The disclosed embodiments provide technical solutions to these and other problems arising from current techniques. For example, various disclosed techniques create efficiencies over current techniques by generating a plurality of instances of a user request. The disclosed techniques may fetch policies across a plurality of policy engines in association with the plurality of instances of the request. The disclosed techniques may evaluate and identify policies and associated network resources to determine network resources accessible to the user. The disclosed techniques may further generate a token or a key that may allow the system to identify additional accessible resources just in time. The disclosed techniques may allow for the efficient evaluation of a large number of policies and associated network resources just in time to provide an accurate, real-time accumulation of accessible network resources to a network identity.

Reference will now be made in detail to the disclosed embodiments, examples of which are illustrated in the accompanying drawings.

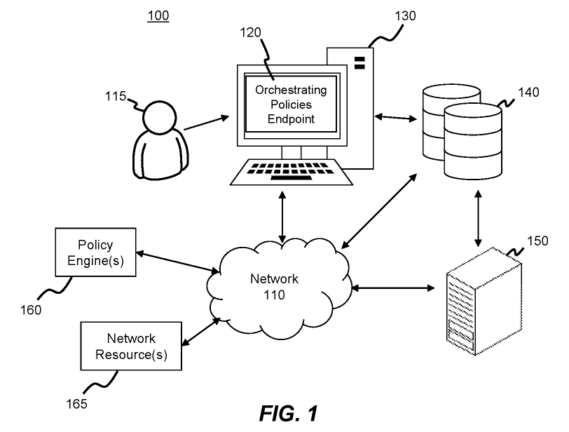

FIG. 1 illustrates an exemplary system 100 for dynamically identifying at least one network resource accessible to a network identity, consistent with the disclosed embodiments. System 100 may represent an environment in which software code is developed and/or executed, for example in a cloud computing environment, on-premises network, or combination of both. System 100 may include orchestrating policies endpoint 120, one or more computing devices 130, one or more databases 140, one or more servers 150, one or more policy engines 160, and one or more network resources 165 as shown in FIG. 1. User 115 may engage with system 100 through computing device 130.

The various components may communicate over a network 110. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system 100 is shown as a network-based environment, it is understood that the disclosed systems and methods may also be used in a localized system, with one or more of the components communicating directly with each other.

Computing devices 130 may be a variety of different types of computing devices capable of developing, storing, analyzing, and/or executing software code. For example, computing device 130 may be a personal computer (e.g., a desktop or laptop), an IoT device (e.g., sensor, smart home appliance, connected vehicle, etc.), a server, a mainframe, a vehicle-based or aircraft-based computer, a virtual machine (e.g., virtualized computer, container instance, etc.), or the like. Computing device 130 may be a handheld device (e.g., a mobile phone, a tablet, or a notebook), a wearable device (e.g., a smart watch, smart jewelry, an implantable device, a fitness tracker, smart clothing, a head-mounted display, etc.), an IoT device (e.g., smart home devices, industrial devices, etc.), or various other devices capable of processing and/or receiving data. Computing device 130 may operate using a Windows™ operating system, a terminal-based (e.g., Unix or Linux) operating system, a cloud-based operating system (e.g., through AWS™, Azure™, IBM Cloud™, etc.), or other types of non-terminal operating systems.

System 100 may further comprise one or more database(s) 140, for storing and/or executing software. For example, database 140 may be configured to store software or code, such as code developed using computing device 130. Database 140 may further be accessed by computing device 130, server 150, or other components of system 100 for downloading, receiving, processing, editing, or running the stored software or code. Database 140 may be any suitable combination of data storage devices, which may optionally include any type or combination of databases, load balancers, dummy servers, firewalls, back-up databases, and/or any other desired database components. In some embodiments, database 140 may be employed as a cloud service, such as a Software as a Service (SaaS) system, a Platform as a Service (PaaS), or Infrastructure as a Service (IaaS) system. For example, database 140 may be based on infrastructure or services of Amazon Web Services™ (AWS™), Microsoft Azure™, Google Cloud Platform™, Cisco Metapod™, Joyent™, vmWare™, or other cloud computing providers. Database 140 may include other commercial file sharing services, such as Dropbox™, Google Docs™, or iCloud™. In some embodiments, database 140 may be a remote storage location, such as a network drive or server in communication with network 110. In other embodiments database 140 may also be a local storage device, such as local memory of one or more computing devices (e.g., computing device 130) in a distributed computing environment.

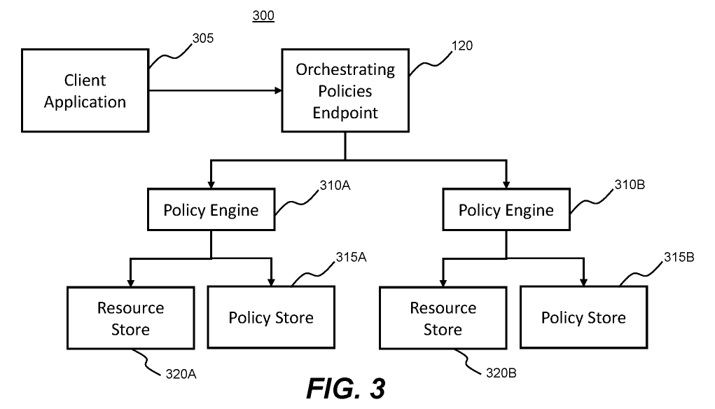

System 100 may also comprise one or more server device(s) 150 in communication with network 110. Server device 150 may manage the various components in system 100. In some embodiments, server device 150 may be configured to process and manage requests between computing devices 130 and/or databases 140. In embodiments where software code is developed within system 100, server device 150 may manage various stages of the development process, for example, by managing communications between computing devices 130 and databases 140 over network 110. Server device 150 may identify updates to code in database 140, may receive updates when new or revised code is entered in database 140, and may participate in dynamically identifying one or more network resource accessible to a network identity as discussed below in connection with FIGS. 3-5.

System 100 may also comprise an orchestrating policies endpoint 120 in communication with network 110. Orchestrating policies endpoint 120 may be any device, component, program, script, or the like, for dynamically identifying one or more network resource accessible to a network identity within system 100, as described in more detail below. Orchestrating policies endpoint 120 may be configured to monitor other components within system 100, including computing device 130, database 140, and server 150. In some embodiments, orchestrating policies endpoint 120 may be implemented as a separate component within system 100, capable of analyzing software and computer codes or scripts within network 110. In other embodiments, orchestrating policies endpoint 120 may be a program or script and may be executed by another component of system 100 (e.g., integrated into computing device 130, database 140, or server 150). Orchestrating policies endpoint 120 may further comprise one or more components for performing various operations of the disclosed embodiments. For example, orchestrating policies endpoint 120 may be configured to receive a request associated with a network identity, identify a first data element associated with the network identity, generate a plurality of instances of the request, fetch two or more policies associated with the network identity, evaluate a batch of one or more policies, and identify one or more network resources accessible to the network identity as discussed below.

System 100 may further comprise at least one policy engine 160. Policy engine 160 may comprise a software component for creating, monitoring, and enforcing rules and policies about how network resources and an organization’s data can be accessed. For example, policy engine 160 may grant role-based permissions that consider multiple factors in accordance with one or more policies. Policy engine 160 may make one or more decisions based on a policy to control a type or level of access to a network resource. In some embodiments, policy engine 160 may be associated with zero standing policies, such as a zero standing privileges policy for a virtual machine (or container instance, or the like), a zero standing privileges policy for a database, a zero standing privileges policy for Kubernetes, a secure cloud console, or any other zero standing policy. In other embodiments, policy engine 160 may be associated with standing policies, such as vault-based permissions, attribute-based access control, or any other standing policy. In other embodiments, policy engine 160 may further be associated with web applications. In other embodiments, policy engine 160 may be associated with other types of access control policies, such as for reviewing sessions auditing information, session metadata, or any other access control policy.

System 100 may further comprise one or more network resource(s) 165. Network resource 165 may refer to any type of computing resource within a network that may be accessed by entities (e.g., users, machines, applications) through a communications network. Examples of network resources 165 may include servers, databases or data structures holding confidential information, restricted-use applications, operating system directory services, access-restricted cloud-computing resources, sensitive IoT equipment, or any other computer-based equipment or software that may be accessible over a network (e.g., network 110). Other examples of network resources 165 may include files, folders, elements in cloud buckets, databases, serverless function settings, logs, computer programs, computer codes, machine executable instructions, or any other type of data that may be stored in a data structure. In some embodiments, network resource 165 may be a privileged resource to which access is limited or restricted. In other embodiments, examples of network resources 165 may include privileged sessions, audits, access rules, or any other privileged computing resources.

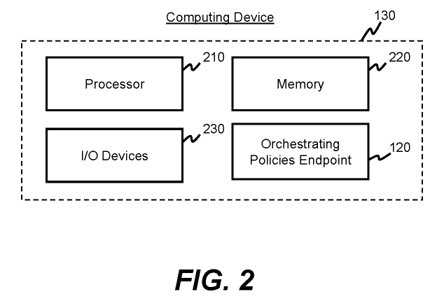

FIG. 2 is a block diagram showing a computing device 130 including orchestrating policies endpoint 120 in accordance with disclosed embodiments. Computing device 130 may include a processor (or processors) 210. Processor (or processors) 210 may include one or more data or software processing devices. For example, processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. Processor 210 may also be based on the ARM architecture, a mobile processor, or a graphics processing unit, etc. In some embodiments, orchestrating policies endpoint 120 may be employed as a cloud service, such as a Software as a Service (SaaS) system, a Platform as a Service (PaaS), or Infrastructure as a Service (IaaS) system. For example, orchestrating policies endpoint 120 may be based on infrastructure of services of Amazon Web Services™ (AWS™), Microsoft Azure™, Google Cloud Platform™, Cisco Metapod™, Joyent™, vmWare™, or other cloud computing providers. The disclosed embodiments are not limited to any type of processor configured in the computing device 130.

Memory (or memories) 220 may include one or more storage devices configured to store instructions or data used by the processor 210 to perform functions related to the disclosed embodiments. Memory 220 may be configured to store software instructions, such as programs, that perform one or more operations when executed by the processor 210 to dynamically identify at least one network resource accessible to a network identity from computing device 130, for example, using process 500, described in detail below. The disclosed embodiments are not limited to software programs or devices configured to perform dedicated tasks. For example, memory 220 may store a single program, such as a user-level application, that performs the functions of the disclosed embodiments or may comprise multiple software programs. Additionally, processor 210 may in some embodiments execute one or more programs (or portions thereof) remotely located from the computing device 130. Furthermore, memory 220 may include one or more storage devices configured to store data (e.g., machine learning data, training data, algorithms, etc.) for use by the programs, as discussed further below.

Computing device 130 may further include one or more input/output (I/O) devices 230. I/O devices 230 may include one or more network adaptors or communication devices and/or interfaces (e.g., WiFi, Bluetooth®, RFID, NFC, RF, infrared, Ethernet, etc.) to communicate with other machines and devices, such as with other components of system 100 through network 110. For example, orchestrating policies endpoint 120 may use a network adaptor to scan for code and code segments within system 100. In some embodiments, the I/O devices 230 may also comprise a touchscreen configured to allow a user to interact with orchestrating policies endpoint 120 and/or an associated computing device. The I/O device 230 may comprise a keyboard, mouse, trackball, touch pad, stylus, and the like.

FIG. 3 is a block diagram of system 300 for dynamically identifying at least one network resource accessible to a network identity. Client application 305 may send a request to orchestrating policies endpoint 120. Client application 305 may comprise a software application that may run on a user device, such as computing device 130, to act as an interface between a user, such as user 115, and orchestrating policies endpoint 120. User 115 may interact with client application 305 through I/O device 230 of computing device 130. Client application 305 may send a request to orchestrating policies endpoint 120 to identify a plurality of network resources accessible to user 115. The request may include an authentication token, or other identification information, associated with user 115. For example, the authentication token may verify an identity of user 115 and may allow orchestrating policies endpoint 120 to identify policies and associated network resources accessible to user 115 based on the data of the authentication token. In some embodiments, the request may also include an identifier, which may be in the form of a key. The identifier may identify the one or more last network resource identified by orchestrating policies endpoint 120 and/or the policy based on which the last network resource was evaluated by orchestrating policies endpoint 120. In such embodiments, the key may be used by orchestrating policies endpoint 120 to identify additional policies and corresponding network resources that have not yet been identified as accessible to user 115. The request may also include one or more filters which may indicate a number of network resources for orchestrating policies endpoint 120 to identify, a type of network resources for orchestrating policies endpoint 120 to identify, or any other filter related to the network resources that may be identified by orchestrating policies endpoint 120.

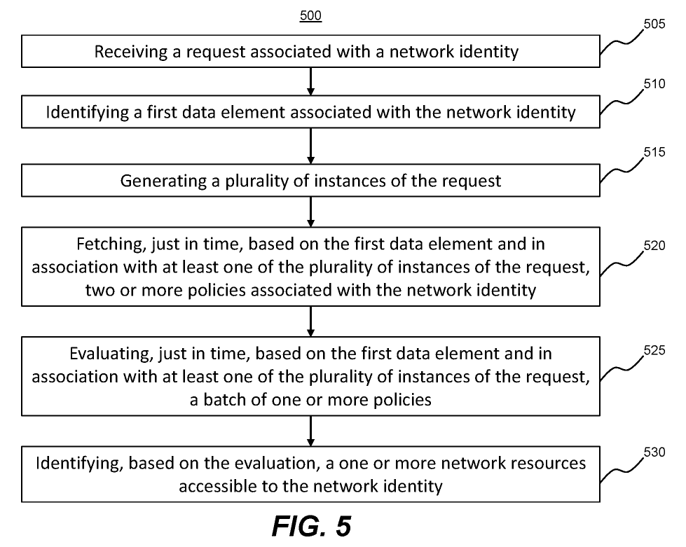

Orchestrating policies endpoint 120 may generate a plurality of instances of the request, as disclosed herein with respect to FIG. 5. Orchestrating policies endpoint 120 may transmit at least one of the plurality of instances of the request to at least one policy engine, such as policy engine 310A and policy engine 310B. Policy engine 310A and policy engine 310B may correspond to policy engine 160. For example, in some embodiments, policy engine 310A may control, monitor, and enforce secure cloud policies. Secure cloud access may provision, monitor, and enforce just-in-time privileged access in multi-cloud environments based on the principle of least-privilege access. Secure cloud policies may manage access by users to cloud management and other cloud-based services and data. In some embodiments, policy engine 310B may control, monitor, and enforce zero standing privileges for virtual machines. Zero standing privilege policies may remove persistent user privileges and provision just-in-time access to resources, services, and data on virtual machines. Orchestrating policies endpoint 120 may transmit at least one of the plurality of instances of the request to each of policy engine 310A and policy engine 310B in parallel, such that policy engine 310A and policy engine 310B may evaluate the instances of the request simultaneously. Although FIG. 3 depicts two policy engines, system 300 may include any number of policy engines.

Policy engine 310A may evaluate allowed policies in policy store 315A and policy engine 310B may evaluate allowed policies in policy store 315B. Policy store 315A may contain policies that may control, manage, and provision access to resources contained in resource store 320A and policy store 315B may contain policies that may control, manage, and provision access to resources contained in resource store 320B. Policy store 315A and policy store 315B may comprise a container for policies and policy templates. Policy engine 310A and policy engine 310B may evaluate whether user 115 meets or exceeds the access requirements of the policies contained in policy store 320A and policy store 320B, respectively. For example, policy engine 310A and policy engine 310B may evaluate the credentials of user 115 provided through the request from client application 305 to determine if the user is allowed to access to particular resources based on the policies of policy store 315A and policy store 315B.

After evaluating a user against the policies contained in policy store 315A and policy store 315B, policy engine 310A may read resource properties from resource store 320A and policy engine 310B may read resource properties from resource store 320B. Resource store 320A and resource store 320B may contain resources that may or may not be accessible to user 115. For example, resource store 320A may include cloud console resources. Cloud console resources may be services, data, or other resources that may be stored in a cloud environment. Resource store 320B may include resources associated with an on-premises virtual machine and/or resources associated with a cloud virtual machine. Each of the network resources stored in resource store 320A and resource store 320B may be associated with at least one policy stored in policy store 315A and policy store 315B, respectively. After policy engine 310A and policy engine 310B have identified policies associated with the user, policy engine 310A and policy engine 310B may identify the one or more network resources that correspond with the policies.

Policy engine 310A and policy engine 310B may return a batch of policies that are associated with user 115 with the respective resources that may be accessed by the user through the policies. Orchestrating policies endpoint 120 may create a combination of accessible resources based on the batches of resources received from policy engine 310A and policy engine 310B. Orchestrating policies endpoint 120 may provide a specific number of accessible network resources to client application 305, based on the number of network resources requested or otherwise determined by client application 305. Orchestrating policies endpoint 120 may further create a token and provide the token with the accumulation of accessible resources to client application 305. The token may allow orchestrating policies endpoint 120 to determine the last identified network resource from each of policy engine 310A and policy engine 310B. If client application 305 transmits a second request to provide additional accessible network resources, orchestrating policies endpoint 120 may use the data from the token to identify the next accessible network resource to be provided by policy engine 310A and policy engine 310B when creating a second accumulation of accessible resources in response to the second request.

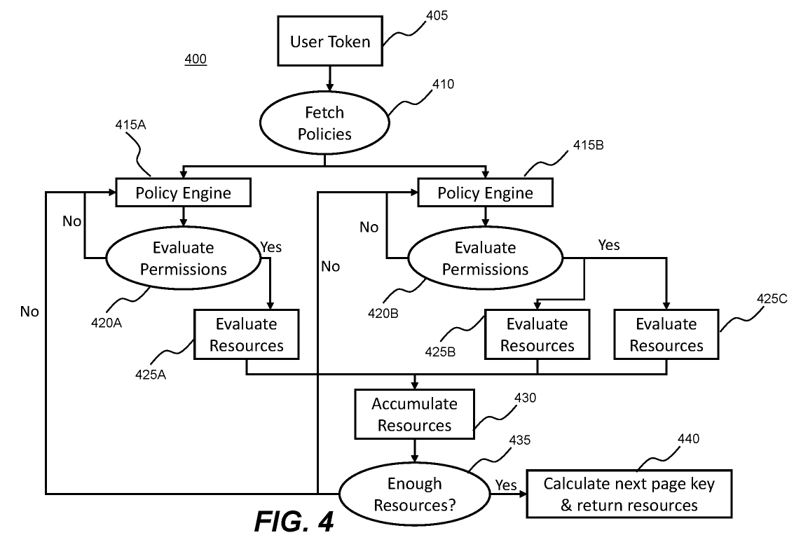

FIG. 4 is a block diagram of process 400 for dynamically identifying at least one network resource accessible to a network identity. At step 405 of process 400, a request may be received from a user, such as user 115. In some embodiments, the request may be received from a client application associated with user 115, such as client application 305 as disclosed herein with respect to FIG. 3. The request may include a request to identify network resources that may be accessible to user 115. The request may include a user token. The user token may contain identification and authentication data of user 115. For example, the token may be used to determine which network resources user 115 may access based on the authentication data of the token.

At step 410 of process 400, policies may be fetched. To fetch policies, a orchestrating policies endpoint, such as orchestrating policies endpoint 120, may generate a plurality of instances of the request. Generating a plurality of instances of the request may allow policies to be fetched, based on each of the plurality of instances of the request, across a plurality of policy engines in parallel or sequentially. At step 415A and step 415B, each of the instances of the request may be transmitted to a policy engine in parallel or sequentially. In some embodiments, the policy engines of process 400 may correspond to policy engine(s) 160, as disclosed herein with respect to FIG. 1. Transmitting the plurality of instances of the request to a plurality of policy engines in parallel or sequentially may allow process 400 to quickly and efficiently identify, just in time, accessible network resources that may be stored in a variety of locations, with a variety of resource types, and varying levels of encryption. Although process 400 includes steps 415A and 415B, a plurality of instances of the request may be transmitted to any number of policy engines.

At step 420A and step 420B, each policy engine may intelligently fetch several policies. Intelligently fetching policies may sort and prioritize policies to identify policies that may be most likely associated with the user token provided in step 405 of process 400. For example, intelligently fetching policies may include fetching policies that may cover many users, fetching policies that may have wide network resource definitions, or fetching policies based on past user behaviors. After fetching one or more policies, each policy engine may evaluate permissions associated with the instances of requests. Each policy engine may determine whether or not a user, such as user 115, has permissions to access network resources under the fetched policies. For example, in some embodiments, each policy engine may determine whether a user has access to network resources according to a policy based on the authentication and identification information provided in the user token in step 405. Each policy engine may evaluate user permissions simultaneously and in real time.

If the policy engine determines that a user does not have permissions under a policy, then process 400 may return to step 415A or step 415B. The policy engine may intelligently fetch additional policies and evaluate user permissions under the additional policies. If the policy engine determines that a user has permission under a policy, then process 400 may proceed to step 425A, step 425B, or step 425C. At step 425A, step 425B, and step 425C, resources may be evaluated. For example, evaluating resources may include matching one or more network resources that are associated with the policy evaluated in steps 420A and 420B. In some embodiments, each policy that has been identified in step 420A and step 420B may be matched with an associated network resource which may be stored in a resource store. Evaluating the resources may occur in a parallel across a plurality of policy engines, so that a plurality of resources may be evaluated simultaneously.

At step 430 of process 400, the network resources identified across a plurality of policy engines in step 425A, step 425B, and step 425C may be accumulated. The network resources that have been determined to be accessible to a user may be accumulated into a list, directory, batch, inventory or any other grouping. At step 435 of process 400, it may be determined whether enough network resources have been fetched and evaluated. For example, the user request received in step 405 of process 400 may include a request for or a determination of a specific number of accessible network resources (e.g., 10, 20, 50, etc.). At step 435, it may be determined whether the accumulated list of resources meets the user request. If it is determined that not enough resources were accumulated, process 400 may return to step 415A and/or step 415B to fetch and evaluate additional policies and network resources. If it is determined that enough resources have been accumulated to meet the user request, then process 400 may proceed to step 440.

At step 440 of process 400, a “next page key” may be calculated. The next page key may allow process 400 to mark and identify the last identified network resource and/or the policy based on which the last network resource was identified. Accordingly, if the user sends a subsequent request for additional accessible network resources, the next page key may be used by process 400 to determine which policies and/or network resources have already been evaluated. After receiving a second request, process 400 may restart and evaluate policies and network resources that were not evaluated in response to the first request, based on the next page key. In some embodiments, the next page key may include the last processed policy ID of each policy engine, and the last resource ID returned to the user. After calculating the next page key, the accessible network resource and next page key token may be returned to the user. If the user sends a subsequent request, process 400 may begin again with step 405. At step 405, the request may include both the user token and the next page key token.

FIG. 5 depicts a flowchart of a process 500 for dynamically identifying at least one network resource accessible to a network identity. Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

Step 505 of process 500 may include receiving a request associated with a network identity. In some embodiments, step 505 of process 500 may correspond to step 405 of process 400, as disclosed herein with respect to FIG. 4. In some embodiments, the request may be a first request associated with a network identity to identify a plurality of network resources that are accessible to the network identity. In such an embodiment, the request may include an authentication token or identification information associated with the network identity. The authentication token may verify an identity of a network identity and allow access to network resources according to one or more policies, as disclosed herein. In some embodiments, the request may be received directly from the network identity. In other embodiments, the request may be received by a system, program, or other component on behalf of the network identity and may include identification information associated with the network identity. Like the authentication token, the identification information associated with the network identity may be used by process 500 to determine whether the network identity may access a plurality of network resources based on a plurality of policies.

Step 510 of process 500 may include identifying a first data element associated with the network identity. In some embodiments, the first data element may include an authentication token. The authentication token may include verification data associated with a network identity and may allow access to network resources according to one or more policies, as disclosed herein. In other embodiments, the first data element may include identification information associated with the network identity. For example, in some embodiments, the first data element may be received from a component on behalf of the network identity. In such embodiments, the first data element may include identification information that is associated with the network identity. Such identification information may be used in process 500 to identify network resources that the network identity may have access to.

Step 515 of process 500 may include generating a plurality of instances of the request. Generating a plurality of instances of the request may allow process 500 to transmit the request to a plurality of policy engines in parallel. Generating a plurality of instances of the request may comprise at least one of fragmenting the request, modifying the request, or duplicating the request. Fragmenting the request may comprise splitting the request into multiple components. Each of the multiple fragments of the request may be transmitted to one of a plurality of policy engines in parallel. In some embodiments, certain policy engines may require that a request be received in a particular format or include particular information. In such embodiments, the request may be modified to meet the requirements of the policy engine. For example, modifying the request may comprise removing data, adding data, reorganizing data, or otherwise changing the data of the original request. Each modified request may be transmitted to the associated policy engine in a format and structure that may be processed by each policy engine. In some embodiments, the request may be duplicated. Duplicating the request may comprise copying the request into multiple instances without modifying the data of the request. Each of the duplicated instances of the request may be transmitted to one of a plurality of policy engines in parallel.

Step 520 of process 500 may include fetching, just in time, based on the first data element and in association with at least one of the plurality of instances of the request, two or more policies associated with the network identity. In some embodiments, fetching the two or more policies associated with the network identity may comprise fetching the two or more policies from multiple policy engines in association with at least one of the plurality of instances of the request. The multiple policy engines may comprise components that generate, manage, control, and enforce rules and policies for accessing data and network resources. Policies may be fetched from multiple policy engines in parallel by transmitting each of the plurality of instances of the request to each of the multiple policy engines. Each policy engine may intelligently fetch a batch of policies. Intelligently fetching policies may sort and prioritize policies to identify policies that may be most likely to be associated with the user based on the first data element identified in step 510 of process 500. For example, intelligently fetching policies may include fetching policies that may cover many users, fetching policies that may have wide network resource definitions, or fetching policies based on past user behaviors. In some embodiments, one or more of the policies may be encrypted. Fetching the one or more access policies may include decrypting the encrypted policies to evaluate a user’s permissions under the policy.

The two or more policies may be fetched just in time to provide accurate, up-to-date responses to the request. Fetching the two or policies just in time may more accurately reflect the network resources that a network identity currently has access to. For example, by fetching the two or more policies just in time, process 500 may identify and return newly accessible network resources and may not identify and return network resources for which a network identity’s access has been revoked or removed. Fetching the two or more policies just in time may efficiently provide an accurate, dynamic and complete identification of accessible network resources.

In some embodiments, the two or more policies may be at least one of: located in two or more data storage locations, associated with two or more policy types, or associated with two or more types of resources. Data storage locations may include an on-premise storage location, a cloud storage location, or a hybrid storage location that may store data and network resources. In some embodiments, the two or more policies may be stored in the on-premise, cloud, or hybrid storage locations in plain text or may be encrypted. In some embodiments, the two or more data storage locations may comprise at least two of a relational database management system, a database, a data warehouse, a key-value store, a document store, a columnar database, a graph database, an in-memory data grid, a file system, or an object storage. A relational database management system may comprise a system that may store, manage, and update relational databases. For example, a relational database management system may include MySQL, PostgreSQL, Oracle Database, or any other relational database management system. A database may comprise an organized collection or structure data or information. For example, a database may include MongoDB, Cassandra, Redis, or any other database system. A data warehouse may include a centralized repository that may store large amounts of data from multiple sources in a structured and organized format for easy analysis and reporting. For example, a data warehouse may include Amazon Redshift, Google BigQuery, Snowflake, or any other data warehouse system. A key-value store may include a non-relational database that uses a key-value method to store data. For example, a key-value store may include Amazon DynamoDB, Redis, or any other key-value store system. A document store may include a non-relational database that may store data in documents. For example, a document store may include Couchbase, MongoDB, Elasticsearch, or any other document store system. A columnar database may include a type of database management system that may store data in columns instead of rows. For example, a columnar database may include Apache Cassandra, HBase, or any other columnar database system. A graph database may include a database that may store data as a network of interconnected nodes and relationships to allow for querying of relationships between entities. For example, a graph database may include Neo4j, Amazone Neptune, or any other graph database system. An in-memory data grid may be a set of networked computers that may share their random-access memory (“RAM”) to enable applications to share data with each other. For example, an in-memory data grid may include Apache Ignite or any other in-memory data grid system. A file system may be a structure to govern organization and access to files. For example, a file system may include NT File System through Windows, ext4 through Linux, HFS+ through macOS, or any other file system. An object storage system may be a computer data storage architecture that stores large amounts of unstructured data. For example, an object storage may include Amazon S3 Google Cloud Storage, Azure Blob Storage, or any other object storage system.

In some embodiments, the two or more policies may be associated with two or more policy types. A policy type may be a set of rules, instructions, or guidelines for accessing a particular network resource. Each of the policy types may comprise rules or guidelines for generating, managing, and granting access to a variety of resource types. Each policy type may comprise different rules and requirements for generating and granting access to different types of network resources. For example, a policy type may include one or more of a policy for accessing a virtual machine zero standing access (e.g., a policy associated with cloud or on-premises virtual machines which may be attribute based access control policies or role based access control policies), a policy for accessing a database zero standing access (e.g., a policy associated with databases that may be stored in different locations, such as in a cloud environment and/or an on-premise environment), a policy for standing access (e.g., a policy associated with accounts or network resources stored in vaults or safes), a policy for accessing a cloud console (e.g., a policy associated with permissions to access a workspace in a cloud provider, such as Amazon Web Services, Azure, or Google Cloud Platform), a policy for accessing a web application (e.g., a policy associated with any web application), a policy for accessing a second policy (e.g., a delegation policy that can be managed only by authorized users), or a policy for authorizing one or more identities. In some embodiments, two or more policies of a same type may be stored in the same location. In other embodiments, two or more policies of a same type may be stored in hybrid or distributed data stores.

In some embodiments, the two or more policies may be associated with two or more types of resources. For example, the two or more types of resources may comprise two or more of a resource associated with a cloud virtual machine, a resource associated with an on-premises virtual machine, a resource associated with an account stored in a vault, or a resource associated with a cloud console workspace.

Step 525 of process 500 may include evaluating, just in time, based on the first data element and in association with at least one of the plurality of instances of the request, a batch of one or more policies. In some embodiments, evaluating the batch of one or more policies may be performed in parallel and just in time. For example, each of the plurality of policy engines that receive at least one of the instances of the request may evaluate a batch of one or more policies simultaneously. Each of the plurality of policy engines may be associated with an orchestrating policies endpoint, such as orchestrating policies endpoint as disclosed herein with respect to FIG. 1. Evaluating the batch of one or more policies in parallel may allow process 500 to evaluate and return accessible network resources to the network identity quickly and efficiently. Evaluating the batch of one or more policies just in time may further ensure that process 500 identifies and evaluates an up-to-date batch of policies that accounts for new users, updates to user metadata, ephemeral or new resources, updates to resource metadata, and other updates that may occur in the policies and resource types. This may ensure that process 500 returns an accurate list of accessible network resources to the network identity.

Each of the policy engines may evaluate whether the network identity has access under the policies stored in the policy engine, based on the first data element identified in step 510 of process 500. For example, the policy engine may use the authentication token or identification information associated with the network identity to determine if the network identity meets the requirements of each of the policies in the batch of policies. If the policy engine determines that a network identity meets the access requirements of a fetched policy, then the policy engine may evaluate the network resources corresponding to the policy. If the policy engine determines that the network identity does not meet the access requirements of the fetched policy, then the policy engine may retrieve and evaluate additional policies.

Step 530 of process 500 may include identifying, based on the evaluation, one or more network resources accessible to the network identity. In some embodiments, identifying the one or more network resources accessible to the network identity may be performed just in time. Identifying the accessible network resources just in time may allow process 500 to accurately determine the network resources that may currently be accessible to a network identity. For example, identifying the network resources just in time may take into account revoked resources, newly allowed resources, new resource types, new policy types, new policy engines, and additional considerations that may affect accessibility. In some embodiments, the batch of one or more policies evaluated in step 525 of process 500 may correspond to a batch of one or more network resources associated with the network identity. For example, if a policy engine associated with an orchestrating policies endpoint determines that a network identity meets the requirements of a policy in step 525 of process 500, then the policy engine may identify the network resource(s) that correspond to that policy. In some embodiments, the batch of one or more network resources may be associated with one of the plurality of instances of the request.

After each policy engine has identified accessible network resources in parallel, all accessible network resources may be accumulated into a list. In some embodiments, the list of accessible network resources may comprise a grouping or batch of network resources which may or may not be sorted, organized, or filtered. The list of network resources may comprise a collection of network resources which may be returned to the network identity. In some embodiments, identifying one or more network resources accessible to the network identity may comprise buffering the network resources accessible to the network identity to equal a page size. In some embodiments, the request from the network identity received in step 505 of process 500 may include a request for a specific number of accessible network resources to be identified. For example, the request received in step 505 of process 500 may include a request for a specific number of network resources which may be displayed on one page of a graphical user interface associated with the network identity, as disclosed herein. The accumulated list of accessible network resources may be evaluated to determine if the list includes enough accessible network resources to meet the request. If the accumulated list does not contain enough accessible network resources to meet the request, then process 500 may be repeated to identify additional policies and corresponding network resources. If the accumulated list contains more network resources than requested, then the accumulated list may be reduced to include the requested number of resources.

Process 500 may further include displaying the one or more network resources accessible to the network identity on a graphical user interface, sending the one or more network resources accessible to the network identity to the network identity, or storing the one or more network resources accessible to the network identity. In some embodiments, the batch of accessible network resources identified and accumulated in step 530 of process 500 may be displayed to the network identity on a graphical user interface. For example, the batch of accessible network resources may be displayed through computing device 130 to user 115. The graphical user interface may display a target type (e.g., the resource or set of resources that may be accessible to the network identity), an IP address associated with the network resource, a Fully Qualified Domain Name (e.g., a complete domain name for a specific computer or host on the internet), if applicable, a hostname associated with the network resource (e.g., a unique, human-readable name that may identify the network resource to allow users to distinguish between devices and network resources), an environment associated with the network resource (e.g., a test environment, a staging environment, a production environment, etc.), a location of the target network resource, a number of accounts that may be associated with the network resource, and the last time the network resource was accessed by the network identity. In some embodiments, the request received at step 505 of process 500 may include a number of accessible network resources to return and the number of accessible network resources may correspond to the page size of the graphical user interface. For example, the graphical user interface may display 25, 50, 100, or any other number of accessible network resources based on the selected page size. In some embodiments, the batch of accessible network resources may be transmitted to the network identity. The batch of accessible network resources may be transmitted over network 110 and may allow network identity to identify the accessible network resources. In other embodiments, the batch of accessible network resources may be stored. For example, the batch of accessible network resources may be stored in a cloud environment, on-premises environment, or hybrid environment. In some embodiments, the batch of accessible network resources may be stored in database 140 or server 150.

In some embodiments, process 500 may further include generating a second data element. The second data element may include a “next page key.” The second data element may be generated based on the accumulation of policies and accessible network resources. The second data element may be generated based on at least one policy index and at least one resource index. For example, the second data element may include an identification of the last processed policy of each policy engine at step 525 of process 500. The second data element may also include an identification of the last network resource returned to the network identity at step 530 of process 500. The second data element may allow process 500 to identify the last evaluated policies and network resources associated with each policy engine. The second data element may be transmitted to the network identity with the batch of accessible network resources. In some embodiments, the first data element identified in step 510 of process 500 may include the second data element. For example, a subsequent request may be received after an initial request. The subsequent request may include a request to display additional network resources that may be accessible to the network identity. In such an embodiment, process 500 may restart to identify additional network resources that have not already been identified and returned to the network identity. In some embodiments, at step 510 of process 500, when the first data element is identified, the first data element may be associated with a plurality of network resources accessible to the network identity. For example, the first data element may identify the network resources that have already been identified through process 500 as accessible to the network identity based on a prior request. In other embodiments, at step 510 of process 500, the first data element may also include the second data element. The second data element may allow process 500 to continue to identify additional policies and network resources that have not yet been identified based on prior requests.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A non-transitory computer readable medium including instructions that, when executed by at least one processor, cause the at least one processor to perform operations for dynamically identifying at least one network resource accessible to a network identity, the operations comprising:
receiving a request associated with a network identity;
identifying a first data element associated with the network identity;
generating a plurality of instances of the request;
fetching, just in time, based on the first data element and in association with at least one of the plurality of instances of the request, two or more policies associated with the network identity wherein the two or more policies are at least one of: located in two or more data storage locations, associated with two or more policy types, or associated with two or more types of resources;
evaluating, just in time, based on the first data element and in association with at least one of the plurality of instances of the request, a batch of one or more policies; and
identifying, based on the evaluation, one or more network resources accessible to the network identity.

2. The non-transitory computer readable medium of claim 1, wherein fetching the two or more policies associated with the network identity comprises fetching the two or more policies from multiple policy engines in association with at least one of the plurality of instances of the request.

3. The non-transitory computer readable medium of claim 2, wherein fetching the two or more policies associated with the network identity comprises fetching the two or more policies in parallel in association with at least one of plurality of instances of the request.

4. The non-transitory computer readable medium of claim 1, wherein generating a plurality of instances of the request comprises at least one of: fragmenting the request, modifying the request, or duplicating the request.

5. The non-transitory computer readable medium of claim 1, wherein the first data element comprises at least one of: an authentication token, or identification information associated with the network identity.

6. The non-transitory computer readable medium of claim 1, wherein the two or more policy types comprise at least two of: a policy for accessing a virtual machine zero standing access, a policy for accessing a database zero standing access, a policy for standing access, a policy for accessing a cloud console, a policy for accessing a web application, a policy for accessing a second policy, or a policy for authorizing one or more identities.

7. The non-transitory computer readable medium of claim 1, wherein the first data element is further associated with the one or more network resources accessible to the network identity.

8. The non-transitory computer readable medium of claim of claim 7, wherein a second data element is generated based on at least one policy index and at least one resource index.

9. The non-transitory computer readable medium of claim 1, wherein the two or more data storage locations comprise at least two of: a relational database management system, a database, a data warehouse, a key-value store, a document store, a columnar database, a graph database, an in-memory data grid, a file system, or an object storage.

10. The non-transitory computer readable medium of claim 1, wherein the two or more data storage locations are at least one of a cloud storage location or an on-premises storage location.

11. The non-transitory computer readable medium of claim 1, wherein the two or more policies are encrypted or are stored as plain text.

12. The non-transitory computer readable medium of claim 1, wherein identifying the one or more network resources accessible to the network identity is performed just in time.

13. The non-transitory computer readable medium of claim 1, wherein the two or more types of resources comprise at least two of: a resource associated with a cloud virtual machine, a resource associated with an on-premises virtual machine, a resource associated with an account stored in a vault, or a resource associated with a cloud console workspace.

14. The non-transitory computer readable medium of claim 1, wherein two or more policies of a same type are stored in a same storage location.

15. The non-transitory computer readable medium of claim 1, wherein two or more policies of a same type are stored in a hybrid data store.

16. The non-transitory computer readable medium of claim 1, wherein the batch of one or more policies corresponds to a batch of one or more network resources associated with the network identity.

17. The non-transitory computer readable medium of claim 16, wherein the batch of one or more network resources is associated with one of the plurality of instances of the request.

18. The non-transitory computer readable medium of claim 8, wherein the first data element comprises the second data element.

19. The non-transitory computer readable medium of claim 1, wherein identifying one or more network resources accessible to the network identity comprises buffering the network resources accessible to the network identity to equal a page size.

20. The non-transitory computer readable medium of claim 1, wherein evaluating, just in time, a batch of one or more policies is performed in parallel.
